(19) United States
(12) Patent Application Publication
(10) Pub. No.: US 2013/0228119 A1
(43) Pub. Date: Sep. 5, 2013

(54) TRANSMISSION INDICATOR FOR VEHICLE

(71) Applicant: Jae Hyun An, Seosan-si (KR)

(72) Inventor: Jae Hyun An, Seosan-si (KR)

(73) Assignees: Kia Motors Corp., Seoul (KR); Hyundai Motor Company, Seoul (KR)

(21) Appl. No.: 13/601,193

(22) Filed: Aug. 31, 2012

(30) Foreign Application Priority Data
Mar. 5, 2012 (KR) 10-2012-0022155

(51) Int. Cl. F16H 63/42

(52) U.S. Cl. 116/28.1

(57) ABSTRACT

A transmission indicator apparatus for a vehicle, may include a lens having a character portion on a side and a diffusion portion on the other side, wherein the diffusion portion may be placed at a position corresponding to the character portion, a light source irradiating light to the diffusion portion, and a PCB circuit equipped with the light source and selectively activating the light source to diffuse and reflect the light toward the character portion from the diffusion portion when the light may be irradiated to the diffusion portion from the light source.

### CROSS-REFERENCE TO RELATED APPLICATION

The present application claims priority to Korean Patent Application No. 10-2012-0022155, filed on Mar. 5, 2012, the entire contents of which is incorporated herein for all purposes by this reference.

### BACKGROUND OF THE INVENTION

1. Field of the Invention

The present disclosure relates to a transmission indicator for a vehicle that shows a light diffusion operation and an illumination effect, the same as when a light guide plate is specifically installed, without individually installing a light guide plate, by integrating the structure and function of a light guide plate with a lens on which characters are indicated.

2. Description of Related Art

In general, vehicles with an automatic transmission are equipped with a transmission indicator that shows which stage the gear is now positioned at in the transmission, in a cluster gauge and a console upper cover.

The transmission indicator displays the stages, generally using characters of P (parking), N (neutral), D (drive), + (stage up), − (stage down), in which the characters are lighted in accordance with the position of a shift lever so that the driver can know which stage the gear is positioned at.

Therefore, a light emitting unit is provided for each of the characters in order to light the characters in the vehicles in the related art so that the number of light sources increases.

FIG. 1 is a view schematically showing a transmission indicator for a vehicle of the related art, in which a PCB circuit 2 is disposed at the upper end of a housing 1 and light sources 3 are disposed at positions, which correspond to the positions of characters showing stages, on the PCB circuit 2, respectively.

That is, the prior transmission indicator of a vehicle keeps lighted in the daytime and night time and the selected stage is lighted with a specific distinguishable color such that the selected stage can be distinguished when the transmission is shifted, and for this configuration, the PCB circuit includes six light emitting units that basically light the characters and six light emitting units having different colors for showing the selected stage for each character.

Therefore, at least two light emitting units are required for each character to increase the manufacturing cost and further there is a limit in the design due to too large volume of the PCB.

FIG. 2 is a view showing another transmission indicator for a vehicle of the related art for solving the problem described above, in which a light guide plate 20 is disposed on a housing 10, one side of the light guide plate 20 printed with light diffusion ink in dots, the upside of the light guide plate 20 is covered with a cover 40 that displays characters, and a diffusion sheet 50 is disposed under the light guide plate 20.

Further, a PCB circuit 30 with a light source is disposed at a side of the light guide plate 20 such that as light is irradiated to the light guide plate 20, the characters formed in the cover 40 is lighted while the light is diffused and reflected by the diffusion ink printed on the light guide plate 20 and the diffusion sheet 50.

In the related art, however, it is necessary to install separately the light guide plate to light the characters by reflecting the light from the light source so that the manufacturing cost necessarily increases due to the light guide plate that is specifically installed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a transmission indicator for a vehicle that shows a light diffusion operation and an illumination effect, the same as when a light guide plate is specifically installed, without individually installing a light guide plate, by integrating the structure and function of a light guide plate with a lens with characters.

In an aspect of the present invention, a transmission indicator apparatus for a vehicle, may include a lens having a character portion on a side and a diffusion portion on the other side, wherein the diffusion portion is placed at a position corresponding to the character portion, a light source irradiating light to the diffusion portion, and a PCB circuit equipped with the light source and selectively activating the light source to diffuse and reflect the light toward the character portion from the diffusion portion when the light is irradiated to the diffusion portion from the light source.

The lens may include a light emitting unit that may have the diffusion portion dented on a side thereof and allows reflection amount and diffusion amount of the light irradiated from the light source to be controlled in the diffusion portion, and a display unit that is disposed on the other side of the light emitting unit and printed with the character portion on an outer side thereof.

The diffusion portion may have a reflective groove dented on the side of the light emitting unit and at least a diffusion projection is formed on an upper inner surface of the reflective groove.

The further the reflective groove from the light source, the deeper the reflective groove is formed.

The further the diffusion groove from the light source, the more the area of the diffusion groove decreases, and density per unit area increases.

The at least a diffusion projection is formed in an embossing shape or a V-shape.

The reflective groove and the at least a diffusion projection are formed by erosion processing.

The light emitting unit and the display unit are formed in a single unit in the lens.

An interface layer is formed between the light emitting unit and the display unit.

The interface layer is an interface through which the light emitting unit and the display unit are faced and in contact with each other, wherein the interface layer is an empty space.

The light emitting unit is transparent so that the light emitted from the light source is reflected to the display unit, the display unit is opaque to block the PCB circuit therein, and the character portion is translucent so that the character portion is recognized when the light source emits the light.

The display unit may include a transparent panel on the light emitting unit, an opaque printed layer on the transparent panel, and a translucent printed layer formed in the character portion in accordance with a shape of a character.

In another aspect of the present invention, a transmission indicator apparatus for a vehicle, comprising a lens that may have a diffusion portion formed in a groove shape on a side and allows reflection amount and diffusion amount of light irradiated from a light source to be controlled in the diffusion portion, wherein the diffusion portion may have a reflective groove dented on the side of the lens and at least a diffusion projection is formed on an upper inner surface of the reflective groove.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically showing the internal structure of a transmission indicator for a vehicle of the related art.

FIG. 2 is a view schematically showing the internal structure of another transmission indicator for a vehicle of the related art.

FIG. 3 is an exploded view showing the configuration of installing a lens in a transmission indicator according to an exemplary embodiment of the present invention.

FIG. 4 is a view showing the shape of the underside of the lens according to an exemplary embodiment of the present invention.

FIG. 5 is a view illustrating reflection of light in a light emitting unit according to an exemplary embodiment of the present invention.

FIG. 6 is a view illustrating reflection of light in the light emitting unit and a diffusion portion according to an exemplary embodiment of the present invention.

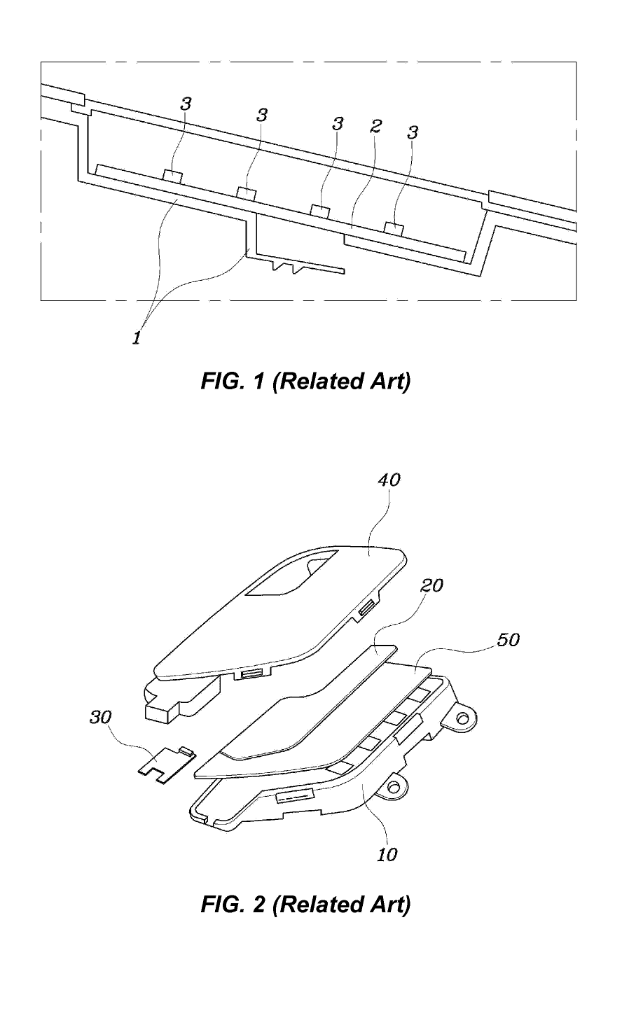

It should be understood that the appended drawings are not necessarily to scale, presenting a somewhat simplified representation of various preferred features illustrative of the basic principles of the invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

Preferred embodiments of the present invention are described hereafter in detail with the accompanying drawings.

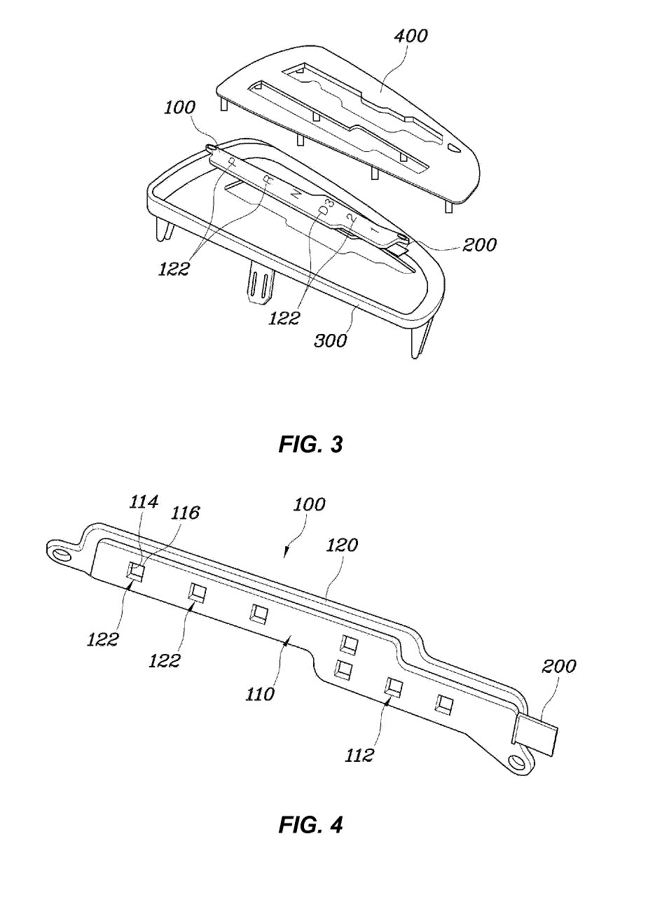

A transmission indicator for a vehicle according to an exemplary embodiment of the present invention shown in FIGS. 3 to 6 may largely include a lens 100 and a PCB circuit 200.

As shown in FIGS. 3 and 4, the lens 100, which is disposed on an upper part of a housing 300 disposed on a console upper cover, is provided with character portions 122 on one side and diffusion portions 112 at the positions corresponding to the character portions 122, on the other side. That is, the character portions 122 are formed on the upside of the lens 100 and the diffusion portions 112 are formed on the underside of the lens 100 such that the character portions 122 and the diffusion portions 112 are integrally designed in the lens 100.

Further, the lens 100 may be assembled with or disposed on a cover 400 covering the upper portion of the housing 300, or may be individually disposed under the cover 400.

The PCB circuit 200 is disposed, with the a light source 210 facing the lens 100, at on one side of the lens 100 such that when light is irradiated from the light source 210 to the diffusion portions 112, the light is diffused and reflected to the character portions 122 from the diffusion portions 112. Preferably, the light source 210 may be an LED in this configuration.

That is, when light is irradiated from the light source 210 toward the lens 100, the light is diffused and reflected through the diffusion portions 112, without a specific light guide plate, and travels to the character portions 122 such that the characters formed in the character portions 122 are lighted.

At this time, a diffusion sheet 500 may be further disposed under the lens 100, and in this configuration, the diffusion sheet 500 reflects the light irradiated from the light source 210 to the lens 100 so that emission efficiency is improved.

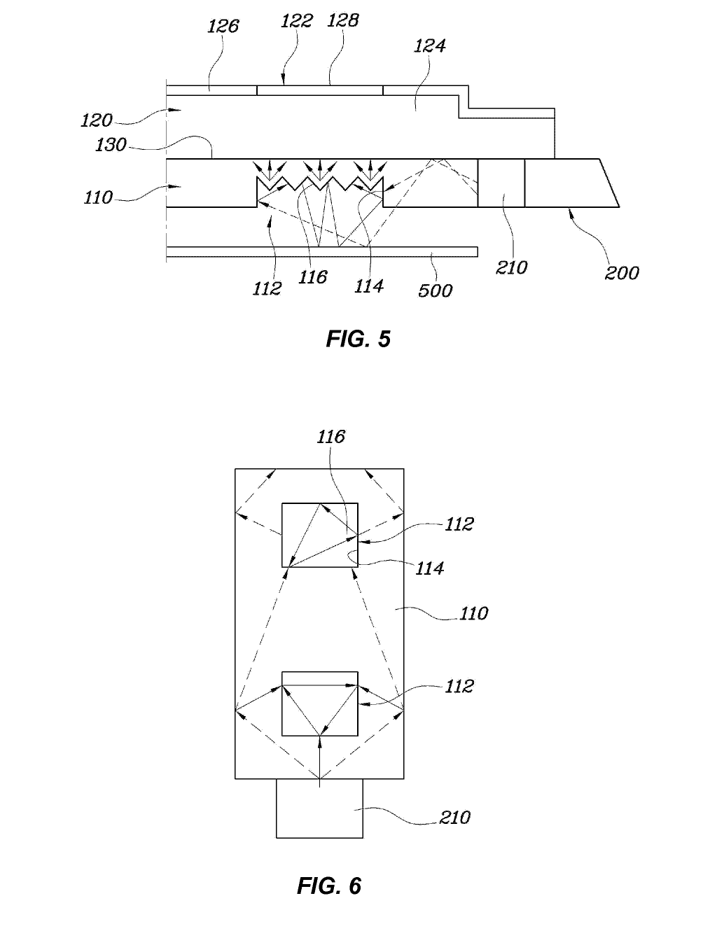

On the other hand, as shown in FIGS. 4 and 5, the lens 100 may include: a light emitting unit 110 that has the diffusion portions formed in a groove shape on one side and controls the reflection amount and the diffusion amount of the light irradiated from the light source 210 at a predetermined direction through the diffusion portions 112, and a display unit 120 that is disposed on the other side of the light emitting unit 110 and printed with the character portions 122 on one outer side.

That is, the lens 100 includes the light emitting unit 110 and the display unit 120 and the diffusion portions 112 are formed in a groove shape on the underside of the light emitting unit 110. In this configuration, the shape of the grooves is preferably a rectangular, and accordingly, the light traveling into the grooves from the light source 210 is reflected several times from the inner sides of the grooves such that the amount of reflected and refracted light increases. Therefore, a larger amount of light can be irradiated to the character portions 122 above the diffusion portions 112 such that the character portions 122 can be lighted brightly.

The characters provided in the character portions 122 may be P, R, N, D, 3, 2, and L, which may be imprinted on an upper side of the display unit 120.

As shown in FIGS. 5 and 6, the diffusion portion 112 according to an exemplary embodiment of the present invention may be formed by forming a reflective groove 114 on one side of the light emitting unit 110 and forming diffusion projections 116 on the surface of the reflective groove 114. The diffusion projections 116 may be formed in an embossing shape or a V-shape.

That is, as the rectangular reflective groove 114 is formed in the diffusion portion 112 and the plurality of diffusion projections 116 are formed on the surface which faces the character portion 122 in the reflective groove 114, the light from the light source is reflected several times from the inner sides of the reflective groove 114 by the structures of the reflective groove 114 and the diffusion projections 116 so that the amount of reflected and refracted light increases.

Further, the diffusion portions 112 are printed at a predetermined distance on the light emitting unit 110 to correspond to the positions of the character portions 122. That is, the diffusion portions 112 are formed not throughout the light emitting unit 10, but at the necessary portions, that is, only under the character portions 122 such that it is possible to reduce unnecessary reflection and sufficiently use light even to the position far from the light source 210. When the diffusion portions 112 are formed throughout the light emitting unit 110, all the light is reflected from a position close to the light source 210 so that sufficient light cannot reach a position far from the light source.

In an exemplary embodiment of the present invention, the further the reflective grooves 114 from the light source 210, the deeper the reflective grooves 114 can be formed. Further, the further the diffusion projections 116 from the light source 210, the closer the diffusion projections 116 can be formed. That is, the less the diameter or the size of the diffusion projections 116, the more the diffusion projections 116 can be formed in a unit area, such that as the distance from the light source increases, the diameter of the diffusion projections 116 decreases and more diffusion projections 116 are formed closer to each other in the reflective grooves 114, which may be expressed by roughness or the degree of thickness of the diffusion projections 116.

That is, a large amount of light is reflected at a portion close to the light source 210 whereas as the distance from the light source 210 increases, the amount of light decreases. Therefore, since as the distance from the light source 210 increases, the reflective grooves 114 formed at the diffusion portions 112 are made deeper and the diffusion projections 116 are formed closer to each other, more amount of light is reflected and refracted from the diffusion portion 112 relatively far from the light source 210 than a diffusion portion 112 close to the light source 210. Therefore, the characters are uniformly lighted, by making the amount of light, which is irradiated from all the diffusion portions 112 to the character portions 122, uniform regardless of the distance from the light source 210.

In an exemplary embodiment of the present invention, the reflective grooves 114 and the diffusion projections 116 may be formed by erosion processing. That is, as the shapes of the reflective grooves 114 and the diffusion projections 116 are formed in a mold by erosion processing, a specific post process (ink printing/pressing or the like) for implementing diffusion means is not necessary so that the cost for the process reduces.

Further, as shown in FIG. 5, the light emitting unit 110 and the display unit 120 of the lens 100 may be formed in one unit. Further, an interface layer 130 may be formed between the light emitting unit 110 and the display unit 120.

That is, the light emitting unit 110 and the display unit 120 of the lens 100 is preferably formed in one unit by insert injection molding or multi-injection molding, in which the interface between the light emitting unit 110 and the display unit 120 makes the interface layer 130. The interface layer 130 may be an interface through which the light emitting unit 110 and the display unit 120 are faced and in contact with each other, or the portion between the light emitting unit 110 and the display unit 120 may be an empty space.

A light source 210 is disposed at a side of the light emitting unit 110 in the lens 100 having the interface layer 130, as described above so that the light from the light source 210 is uniformly reflected in the light emitting portion 110 and reaches the display unit 120 so that the display unit 120 is lighted with a desired color.

In an exemplary embodiment of the present invention, the light emitting unit 110 may be transparent such that the light emitted from the light source 210 is reflected to the display unit 120, the display unit 120 may be opaque to block the PCB circuit 200 therein, and the character portions 122 may be translucent such that the character portions 122 can be recognized when the light source 210 emits light.

This configuration may be achieved by cutting the character portions 122 with a laser and then applying translucent paint, or making the entire display unit 120 opaque in forming and making the character portions 122 translucent. That is, since the character portions 122 are made translucent, they can be made not shown in a normal state and shown when the light source 210 emits light.

In an exemplary embodiment of the present invention, the display unit 120 includes a transparent panel 124 and an opaque printed layer 126 on the panel 124, and a translucent printed layer 128 may be formed in the character portion 122 in accordance with the shape of the character.

That is, the display unit 120 is basically formed of a transparent panel 124 to transmit the light from the light source 210 disposed under the display unit 120. The opaque printed layer 126 is, for example a black paint layer, and blocks light. Therefore, the display unit 120 blocks the lower inner structure. Further, the translucent printed layer 128 in the character portion 122 is a translucent paint layer with a white color or various colors, for example, and is shown with the color of the paint and blocks the inner structure in the normal state and lighted with the corresponding color when light is emitted.

The operation and effect of the present invention are described in detail with reference to FIGS. 5 and 6.

When light is emitted from the light source 210 on the PCB circuit 200, the light from the light source travels in the thickness direction of the light emitting unit 110 of the lens 100 and is reflected in the longitudinal direction of the light emitting unit 110.

When the light reflected inside the light emitting unit 110 reaches the diffusion portion 112, the light is reflected several times inside the reflective groove 114 because the reflective groove 114 is formed in the diffusion portion 112 so that reflection amount of light increases. Therefore, the light remains longer in the region of the diffusion portion than other regions so that emission efficiency at the diffusion portion 112 increases.

Further, since the diffusion projections 116 is formed on the surface of the reflective grooves 114, the light reflected from the reflective groove 114 is diffused to the display unit 120 by the diffusion projections 116 so that the character portion 122 formed above the diffusion portion 112 can be lighted. Therefore, the character portions 122 can be lighted and the characters of the stages can be lighted by the light irradiated from the light source 210.

As described above, according to an exemplary embodiment of the present invention, since the light irradiated from the light source 210 is reflected and diffused to the display unit 120 through the light emitting unit 110 formed in the lens 100 and the characters of the character portions 122 are lighted, the characters are lighted only by one light source 210 without using a specific light guide plate. Therefore, it is possible to achieve an effect of lighting characters, the same as when using a light guide plate, without using a light guide plate, such that it is possible to reduce the producing and manufacturing costs of a transmission indicator because a light guide plate is not necessary.

Further, since the reflective groove 114 and the diffusion projections 116 of the diffusion portion 112 are formed in the light emitting unit 110 by erosion processing, a specific post process for implementing a diffusion means is not necessary so that the cost for implementing a diffusion means is saved.

Further, since the further the diffusion portions 112 in the light emitting unit 110 from the light source, the more the reflection amount and diffusion amount of light increase, the characters are lighted with uniform illumination and brightness regardless of the distances from the light source 210 so that the commercial value of the product is maximized.

Although the present invention is described above in detail with reference to the exemplary embodiments, it is apparent for those skilled in the art that the present invention may be changed and modified in various ways without departing from the scope of the present invention and it should be understood that the changes and modifications are included in claims.

According to an exemplary embodiment of the present invention, since light irradiated from one light source is reflected and diffused to a display unit through a light emitting unit formed in a lens and characters are lighted, it is possible to achieve an effect of lighting characters, the same as when using a light guide plate, without using a light guide plate so that it is possible to reduce the producing and manufacturing costs of a transmission indicator because a light guide plate is not necessary.

Further, since the reflective groove and the diffusion projections of the diffusion portion are formed in the light emitting unit by erosion processing, a specific post process for implementing a diffusion means is not necessary so that the cost for implementing a diffusion means is saved.

Further, since the further the diffusion portions in the light emitting unit from the light source, the more the reflection amount and diffusion amount of light increase, the characters are lighted with uniform illumination and brightness regardless of the distances from the light source, such that the commercial value of a transmission indicator is maximized.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission indicator apparatus for a vehicle, comprising:
a lens having a character portion on a side and a diffusion portion on the other side, wherein the diffusion portion is placed at a position corresponding to the character portion;
a light source irradiating light to the diffusion portion; and
a PCB circuit equipped with the light source and selectively activating the light source to diffuse and reflect the light toward the character portion from the diffusion portion when the light is irradiated to the diffusion portion from the light source.

2. The transmission indicator apparatus of claim 1, wherein the lens include:
a light emitting unit that has the diffusion portion dented on a side thereof and allows reflection amount and diffusion amount of the light irradiated from the light source to be controlled in the diffusion portion; and
a display unit that is disposed on the other side of the light emitting unit and printed with the character portion on an outer side thereof.

3. The transmission indicator apparatus of claim 2, wherein the diffusion portion has a reflective groove dented on the side of the light emitting unit and at least a diffusion projection is formed on an upper inner surface of the reflective groove.

4. The transmission indicator apparatus of claim 3, wherein the further the reflective groove from the light source, the deeper the reflective groove is formed.

5. The transmission indicator apparatus of claim 3, wherein the further the diffusion groove from the light source, the more the area of the diffusion groove decreases, and density per unit area increases.

6. The transmission indicator apparatus of claim 3, wherein the at least a diffusion projection is formed in an embossing shape or a V-shape.

7. The transmission indicator apparatus of claim 3, wherein the reflective groove and the at least a diffusion projection are formed by erosion processing.

8. The transmission indicator apparatus of claim 2, wherein the light emitting unit and the display unit are formed in a single unit in the lens.

9. The transmission indicator apparatus of claim 2, wherein an interface layer is formed between the light emitting unit and the display unit.

10. The transmission indicator apparatus of claim 9, wherein the interface layer is an interface through which the light emitting unit and the display unit are faced and in contact with each other.

11. The transmission indicator apparatus of claim 9, wherein the interface layer is an empty space.

12. The transmission indicator apparatus of claim 2, wherein the light emitting unit is transparent so that the light emitted from the light source is reflected to the display unit, the display unit is opaque to block the PCB circuit therein, and the character portion is translucent so that the character portion is recognized when the light source emits the light.

13. The transmission indicator apparatus of claim 2, wherein the display unit includes:
a transparent panel on the light emitting unit;
an opaque printed layer on the transparent panel; and
a translucent printed layer formed in the character portion in accordance with a shape of a character.

14. A transmission indicator apparatus for a vehicle, comprising a lens that has a diffusion portion formed in a groove shape on a side and allows reflection amount and diffusion amount of light irradiated from a light source to be controlled in the diffusion portion,
wherein the diffusion portion has a reflective groove dented on the side of the lens and at least a diffusion projection is formed on an upper inner surface of the reflective groove.
